(19) United States
(12) Patent Application Publication
(10) Pub. No.: US 2016/0156643 A1
(43) Pub. Date: Jun. 2, 2016

(54) APPARATUS AND METHOD FOR GENERATING PROCESS ACTIVITY PROFILE

(71) Applicant: ELECTRONICS AND TELECOMMUNICATIONS RESEARCH INSTITUTE, Daejeon (KR)

(72) Inventor: Yang Seo CHOI, Daejeon (KR)

(21) Appl. No.: 14/802,688

(22) Filed: Jul. 17, 2015

(30) Foreign Application Priority Data
Dec. 2, 2014 (KR) 10-2014-0170485

(51) Int. Cl. H04L 29/06

(52) U.S. Cl. CPC H04L 63/1416; H04L 63/1425

(57) ABSTRACT

An apparatus and method for generating a process activity profile are provided. The apparatus includes a basic process profile generator configured to perform basic process profiling for generating a basic process profile recording an operation of a specific process in a system; and an extension process profile generator configured to generate an extension process profile by associating an additional basic process profile generated by executing an execution file downloaded or created while generating the basic process profile with a conventional basic process profile

### CROSS-REFERENCE TO RELATED APPLICATION

This application claims priority to and the benefit of Korean Patent Application No. 10-2014-0170485, filed on Dec. 02, 2014, the disclosure of which is incorporated herein by reference in its entirety.

### BACKGROUND

1. Field of the Invention

The present invention relates to technology expressing a process activity in a computer system, and more particularly, to an apparatus and method for generating a process activity profile which generates a profile expressing an activity of a process performed in a system.

2. Discussion of Related Art

Most cyber attacks which have been recently generated are advanced persistent threat (APT) attacks such as a “3.20 cyber terror” attack. Since the attacks attempt an attack using a new malicious program which is not known, there is a limitation in detecting the attacks using a rule-based computer antivirus program, etc.

In order to solve the limitation, an activity-based detection method such as abnormal detection is applied, but it is difficult to detect since features of the recently generated cyber attacks are very similar to an activity of a normal program.

For example, when analyzing an amount of average traffic or an HTTP GET request activity during a predetermined time, it is not easy to differentiate the malicious activity using the activity-based detection method since it is not different from an activity in which a normal user uses.

As such, the main reason why it is difficult to detect these latest attacks is because the attack detection methods attempt to detect the malicious activity based on a single process.

That is, when a specific program is executed at a certain time, an analysis on an activity which the executed program performs is started, and it is difficult to classify the malicious file since the activity is mostly similar to the normal activity.

In order to solve the problem, activities of a plurality of programs executed on the system should be integrally analyzed. That is, it may require not the analysis on a simple program or each process but the activity analysis on a system.

Further, in order to simultaneously analyze activity information on a plurality of associated processes, a related information collection period should be longer than a conventional statistical information collection period. However, studies regarding a method of generating the activity profile of a monitoring target system itself through an integral analysis on the plurality of associated processes executed in the monitoring target system for an extended period of time are not actively being processed.

### SUMMARY OF THE INVENTION

The present invention is directed to an apparatus and method of generating a process activity profile which generates a profile expressing an activity of every process associated with a specific process and a corresponding process performed in a system.

According to one aspect of the present invention, there is provided an apparatus for generating a process activity profile, including: a basic process profile generator configured to perform basic process profiling for generating a basic process profile recording an operation of a specific process in a system; and an extension process profile generator configured to generate an extension process profile by associating an additional basic process profile generated by executing an execution file downloaded or created while generating the basic process profile with a conventional basic process profile.

The basic process profile generated by the basic process profile generator may include a profile with respect to an execution operation, a file creation operation, a connection creation operation, a file upload operation, a file download operation, and a termination operation.

The apparatus for generating the process activity profile may further include a profile storage unit configured to store the basic process profile generated by the basic process profile generator and the extension process profile generated by the extension process profile generator.

The basic process profile generated by the basic process profile generator and the basic process profile added by the extension process profile generator may include sequence information.

According to one aspect of the present invention, there is provided a method of generating a process activity profile, including: executing basic process profiling for generating a basic process profile recording an operation of a specific process in a system; and executing extension process profiling generating an extension process profile by associating an additional basic process profile generated by executing an execution file downloaded or created through the basic process profiling with a conventional basic process profile.

The method of generating the process activity profile, after the executing of the basic process profiling, may further include: storing the basic process profile generated in the executing of the basic process profiling in a storage unit.

The method of generating the process activity profile, after the executing of the extension process profiling, may further include: storing the extension process profile generated in the executing of the extension process profiling in a storage unit.

The method of generating the process activity profile, after the executing of the extension process profiling, may further include: determining whether the process is malicious using the extension process profile generated in the executing of the extension process profiling.

The basic process profile generated in the executing of the basic process profiling may include a profile with respect to an execution operation, a file creation operation, a connection creation operation, a file upload operation, a file download operation, and a termination operation.

The basic process profile generated in the executing of the basic process profiling and the basic process profile added in the executing of the extension process profiling may include sequence information.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating an attack process of a “3.20 cyber terror” attack;

FIG. 2 is a diagram illustrating a basic process profile model according to an embodiment of the present invention;

FIG. 3 is a diagram illustrating a structure of an extension process profile according to an embodiment of the present invention;

FIG. 4 is a diagram illustrating an apparatus for generating a process activity profile according to an embodiment of the present invention; and

FIG. 5 is an operational flowchart for describing a method of generating a process activity profile according to an embodiment of the present invention.

FIG. 6 is a block diagram illustrating a computer system to which the present invention is applied.

### DETAILED DESCRIPTION OF EXEMPLARY EMBODIMENTS

The above and other objects, features, and advantages of the present invention will become more apparent to those of ordinary skill in the art by describing in detail exemplary embodiments thereof with reference to the accompanying drawings. However, the present invention is not limited to exemplary embodiments which will be described hereinafter, and can be implemented by various different types. Exemplary embodiments of the present invention are described below in sufficient detail to enable those of ordinary skill in the art to embody and practice the present invention. The present invention is defined by claims. Throughout this specification, like numerals represent like components.

When a detailed description with respect to a well-known function or configuration is determined to obscure the gist of the present invention in the following description of the exemplary embodiments of the present invention, a detailed description thereof will be omitted. The terms used hereinafter are defined by considering a function in exemplary embodiments of the invention, and their meaning may be changed according to intentions or customs, etc. of a user, an operator. Accordingly, the terminology will be defined based on the content throughout this specification.

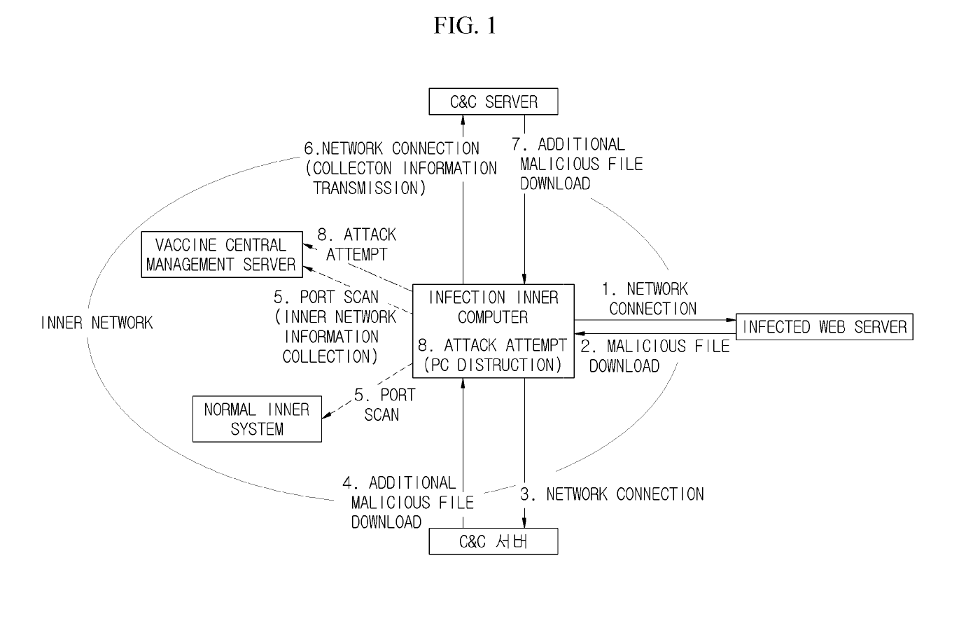

FIG. 1 is a diagram illustrating an attack process of a “3.20 cyber terror” attack., the most important feature that may be confirmed through FIG. 1 is a malicious program which is downloaded through a network connection, the downloaded malicious program is executed, and a new malicious program is additionally downloaded. That is, in order to obtain a desired result by an attacker, a plurality of malicious programs each serving a role may be downloaded and executed.

The present invention may offer a system profiling method expressing a multi-process activity so as to express features such as network connection, file download and execution, etc. by which the plurality of associated processes are performed.

At this time, the present invention may proceed with profiling in two operations in order to generate profiles with respect to the plurality of associated processes. That is, when a specific process is executed, a basic process profiling operation of generating a basic process profile expressing an operation of a corresponding process, and an extension process profiling operation of generating an extended process profile expressing an additional execution file generated by the operation of the corresponding process or the operation of the process may be included.

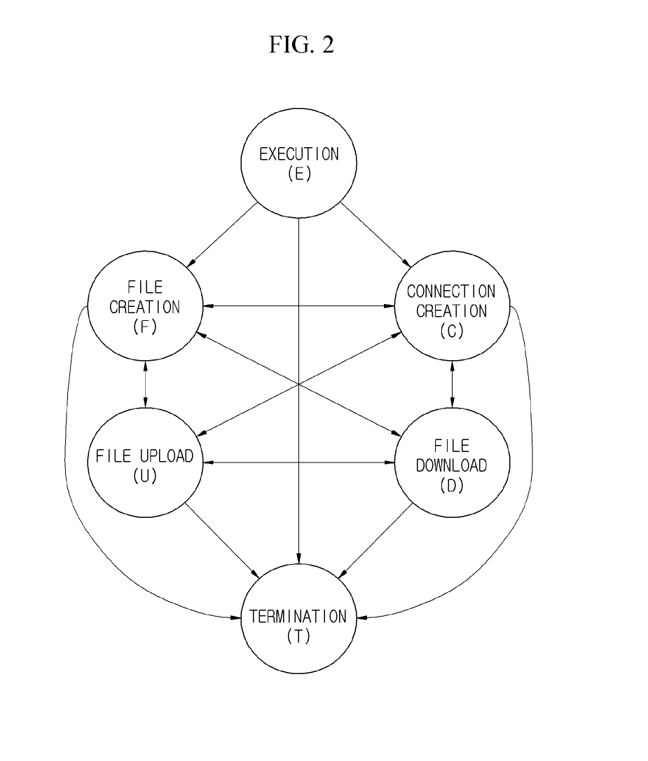

FIG. 2 is a diagram illustrating a basic process profile model according to an embodiment of the present invention.

The basic process profile may be a profile for expressing the operation of the corresponding process when one process is executed, and expression of the operation of the process may be expressed by sequentially arranging the execution of each component.

Referring to FIG. 2, the basic process profile model according to an embodiment of the present invention may be divided into a total of six models such as an execution model, a file creation model, a connection creation model, a file upload model, a file download model, and a termination model.

At this time, most important is use of the download information, file generation information, and connection generation information of a file in order to express the process activity.

However, the basic process profile model may not only be configured of the six basic process profiles described above, and the basic process profile may be configured of many more basic process profiles in order to express the operation of the process executed when executing the system.

For example, a new connection may be generated by executing a process A, and when the process A is terminated after a file is downloaded, a corresponding process may be expressed in the sequence of E (execution)→C(connection generation)→D (file download)→T (termination).

As another example, a process which does not absolutely use a network and is executed only in one system may be expressed in the sequence of E (execution)→F(file creation)→T (termination) or E (execution)→T (termination).

At this time, each basic process profile may express a variety of additional information besides information with respect to the corresponding activity, and the additional information may be information for utilizing when conversely configuring operations of the next process.

A detailed definition and the additional information with respect to each basic process profile are shown in the following Table 1.

TABLE 1

| Basic process | | |
|---|---|---|
| profile | Definition | Additional information |
| Execution(E) | An operation in which a | An execution time, a file name, a |
| | certain process is executed, a | file location, a process name, an |
| | first operation of a profile with | execution attribute, whether to be |
| | respect to every process as a | automatically executed, a parent |
| | start operation of profiling | process name, a previous process |
| | | name on an extended process |
| | | profile, a previous profile name on |
| | | the extended process profile, a next |
| | | process name on the extended |
| | | process profile, a next profile name |
| | | on the extended process profile |
| File generation(F) | An operation in which a | A file name of, a creation time, a |
| | process generates a file, a | file location, a file size, a file |
| | method of generating the file | attribute, a file extension, a file |
| | may be various applied | creation method, a file creation |
| | methods such as a copy, a | process name, a file creation |
| | creation, a download, etc. | program name, and a file creation |
| | | program location of a generated |
| | | file |
| Connection | An operation in which a | A connection time, whether a |
| generation(C) | process generates network | connection setting is completed, a |
| | connection, including cases of | source/destination IP address, a |
| | TCP SYN, and a binding | source/destination port number, a |
| | | protocol, a service |
| File upload(U) | An operation in which a | An outside transmission time, a file |
| | process transmits a system | name, a file location, a file |
| | inner file to the outside | extension, and a file size of an |
| | through network connection | uploaded file, a source/destination |
| | | IP address, a source/destination |
| | | port number, a protocol, a service |
| File download(D) | An operation in which a | A file download time, a file name, |
| | process downloads a file | a file location, a file extension, a |
| | through network connection | file size of a downloaded file, a |
| | | source/destination IP address, a |
| | | source/destination port number, a |
| | | protocol, a service |
| Termination(T) | An operation in which a | A process termination time, the |
| | process is terminated | number of associated processes, an |
| | | associated process list |

Here, the additional information stored in each basic process profile may be confirmed even when being extensively configured in a next extension process profile type, and various features of a corresponding extension process profile may be extracted using the additional information.

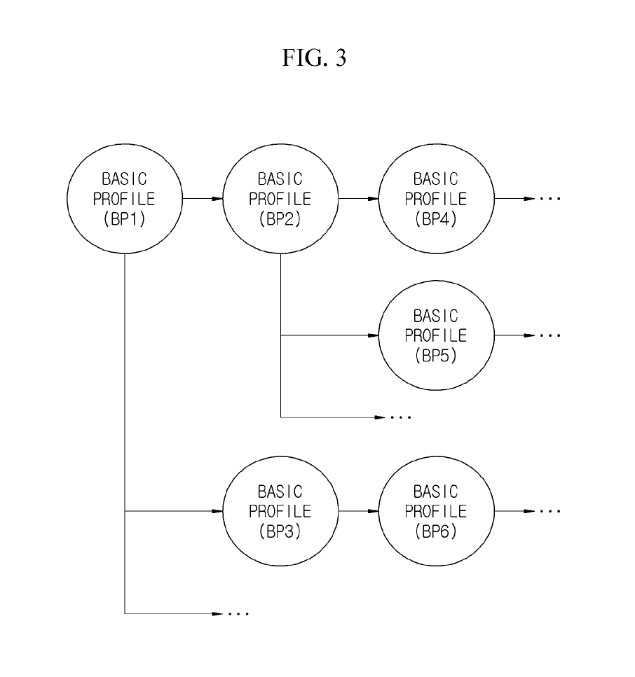

Meanwhile, FIG. 3 is a diagram illustrating a structure of an extension process profile according to an embodiment of the present invention.

Referring to FIG. 3, the extension process profile according to an embodiment of the present invention may be expressed as a group of a series of basic process profiles, and may include sequence information on the basic process profiles which are individual members of the group.

Here, the basic process profiles included in the extension process profile are related to the processes which may be downloaded by a preceding basic process (for example, BP1 in the case of BP2, BP2 in the case of BP4), or may be processes executed by executing the generated file.

In other words, a specific execution file is downloaded while a certain process is executed, and when the downloaded execution file is executed in the future, basic process profiles of two processes may be associated within the extension process profile.

Further, when a child process is generated while a certain process is executed, the basic process profile with respect to the child process may be associated with the extension process profile.

A profile with respect to a long-term activity of the processes associated with the certain process according to the method described above may be generated.

In an example shown in FIG. 3, when two files are downloaded and a corresponding file is executed in the future while a certain process is executed according to the basic process profile BP1, the basic process profile with respect to the two processes may be associated with the initial basic process profile BP1, and the profiling on the basic process profiles BP2 and BP3 may be performed in parallel.

Accordingly, the extension process profile may have a structure extended due to a plurality of basic process profiles having a tree structure.

At this time, in FIG. 3, each basic process profile configuring the extension process profile may execute at least one operation among operations shown in FIG. 2.

Meanwhile, the extension process profile structure may be expressed by various types of equations, and as an example, in order to process a command instructed by a system user, assume that a process P may be executed, and may be terminated T after an execution file F1 is created by sequentially executing the connection creation C and the file creation F, and when the execution file F1 is executed E by executing the file creation F, may be terminated T after the connection creation C is executed.

The extension process profile structure executing the operation described above may be expressed as P(E, C, F:F1, T)/PF1(E, C, T).

The profile of a method proposed in the present invention may be used for detecting a malicious activity in a specific system. A method of detecting the malicious activity using the profile of the present invention will be described briefly.

First, a profile may be generated using the method described above with respect to a normal system which is not infected with a malicious file. When generating the profile with a plurality of normal processes over an extended period of time, for example, six months, a corresponding profile may be a normal profile.

When the normal program is normally executed, an activity of a corresponding process and information with respect to a relationship between other processes associated with the corresponding process may be collected in the profile generated by the normal process. In the future, when a file about which there is a question about its normality or abnormality executes a specific activity, there may be a high probability of a profile generated by the malicious activity when the profile of the process is an activity which is difficult to find in the normal profile.

As such, whether a specific program is malicious may be determined by comparing a conventionally learned profile and a newly generated profile and determining whether they are the same type. Here, in order to determine whether the specific program is malicious, various machine learning or clustering algorithms such as a Baysian network or a support vector machine (SVM), etc. may be used.

Further, when generating the profile while the plurality of malicious programs is collected and executed, the malicious profile may be generated, and when the activity profile with respect to the certain process is a type similar to the malicious profile, the activity as a result of the execution of the corresponding process executes may be suspected as the malicious activity. In this case, the machine learning or the grouping algorithm may be used.

Structures of the basic process profile and the extension process profile according to an embodiment of the present invention were described above. Hereinafter, an apparatus for generating a process activity profile will be described.

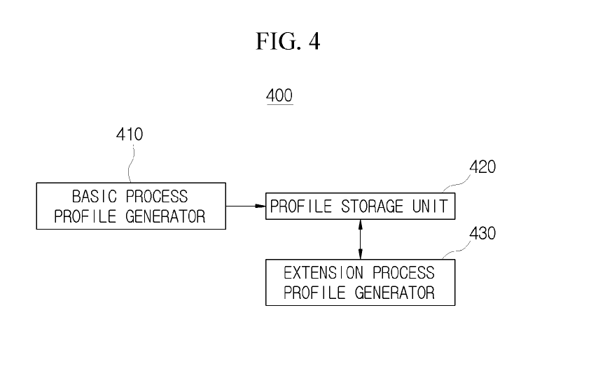

FIG. 4 is a diagram illustrating an apparatus for generating a process activity profile according to an embodiment of the present invention.

Referring to FIG. 4, the apparatus 400 for generating the process activity profile in a system may include a basic process profile generator 410, a profile storage unit 420, and an extension process profile generator 430.

The basic process profile generator 410 may perform basic process profiling for generating the basic process profile recording an operation of a process.

At this time, the process profile generated by the basic process profile generator 410 may include an execution operation, a file creation operation, a connection creation operation, a file upload operation, a file download operation, and a termination operation.

Further, the basic process profile generated by the basic process profile generator 410 may include sequence information.

The profile storage unit 420 may store the basic process profile generated by the basic process profile generator 410. Further, the profile storage unit 420 may store the extension process profile generated by the extension process profile generator 430.

The extension process profile generator 430 may generate the extension process profile by associating the basic process profile generated by executing an additional execution file downloaded or created while the specific process is executed with the basic process profile generated in the basic process profile generator 410.

At this time, the extension process profile generated by the extension process profile generator 430 may be stored in the profile storage unit 420.

Further, the basic process profile generated according to the execution of the additional execution file in the extension process profile generator 430 may include at least one among an execution operation, a file creation operation, a connection creation operation, a file upload operation, a file download operation, and a termination operation.

Moreover, the basic process profile which is additionally generated by the extension process profile generator 430 may include sequence information.

The apparatus for generating the process activity profile in the system according to an embodiment of the present invention was described above. Hereinafter, a method of generating the process activity profile in the system using the basic process profile and the extension process profile will be described.

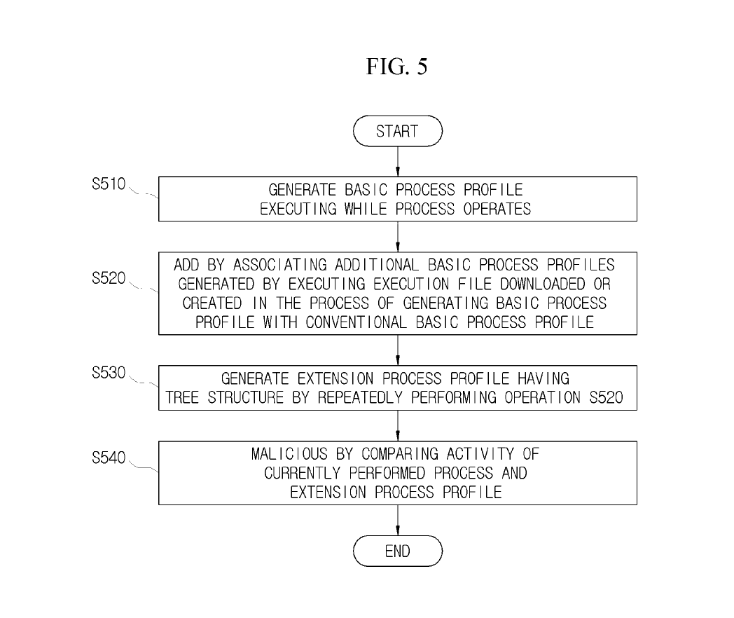

FIG. 5 is an operational flowchart for describing a method of generating a process activity profile according to an embodiment of the present invention.

Referring to FIG. 5, in order to generate the process activity profile in the system according to an embodiment of the present invention, first, basic process profiling for generating the basic process profile recording a specific process operation in the system may be performed (S510).

At this time, the basic process profile generated according to the basic process profiling may include an execution operation, a file creation operation, a connection creation operation, a file upload operation, a file download operation, and a termination operation.

Further, when generating the basic process profile according to the basic process profiling, additional information with respect to each operation may be generated, and the additional information may be used when conversely configuring operations in the structure of the extension process profile.

Moreover, when generating the basic process profile according to the basic process profiling, the generated basic process profile may include sequence information.

Based on the operation S510, the extension process profiling in which addition by associating the additional basic process profile generated by executing the execution file downloaded or created in the process of generating the basic process profile with a conventional basic process profile may be performed (S520).

At this time, the basic process profile generated while additionally executing the execution file downloaded or created while generating the basic process profile may include at least one among an execution operation, a file creation operation, a connection creation operation, a file upload operation, a file download operation, and a termination operation.

Further, the basic process profile added by associating with the basic process profile according to the extension process profiling may include sequence information.

After this, the extension process profile having a tree structure may be generated by repeatedly performing the operation S520 (S530).

The extension process profile generated by performing the operations S510 to S530 may be used for determining whether the process is malicious.

Accordingly, after generating the extension process profile according to the operation S530, an operation (S540) of determining whether a process which is currently performed is malicious may be further performed by comparing the activity of the currently performed process and the extension process profile.

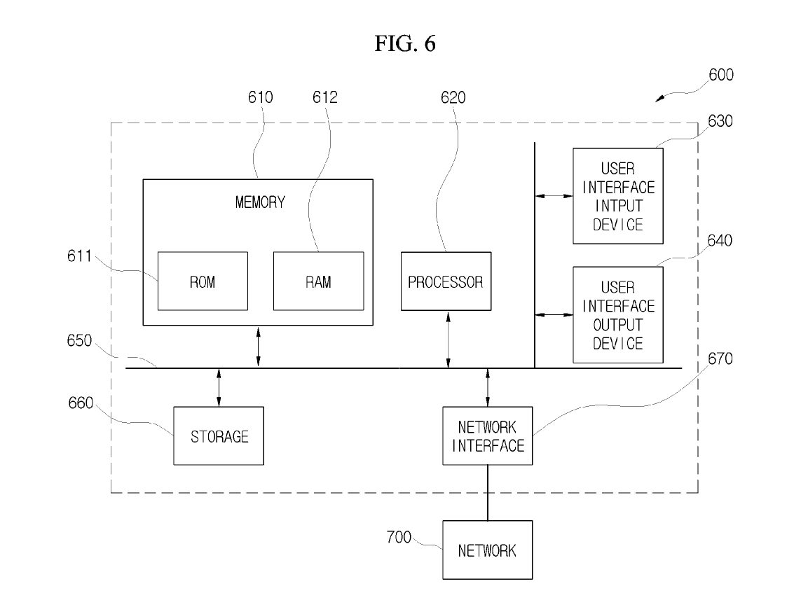

An embodiment of the present invention may be implemented in a computer system, e.g., as a computer readable medium. As shown in FIG. 6, a computer system 600 may include one or more of a processor 620, a memory 610, a user interface input device 630, a user interface output device 640, and a storage 660, each of which communicates through a bus 650. The computer system 600 may also include a network interface 670 that is coupled to a network 700. The processor 620 may be a central processing unit (CPU) or a semiconductor device that executes processing instructions stored in the memory 610 and/or the storage 660. The memory 610 and the storage 660 may include various forms of volatile or non-volatile storage media. For example, the memory may include a read-only memory (ROM) 611 and a random access memory (RAM) 612.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the present invention, the activities of the plurality of processes associated with not only the specific single process but also the corresponding process may be defined and expressed through the activities such as the file creation, the file download, and the connection creation, etc.

Accordingly, when the process activity profile in the system generated by the method of generating the process activity profile according to the present invention is used for detecting the malicious activity, the attack of the APT type performing the attack using the plurality of processes which cannot be classified by the conventional malicious activity detection method can be detected.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for generating a process activity profile, comprising:
a basic process profile generator configured to perform basic process profiling for generating a basic process profile recording an operation of a specific process in a system; and
an extension process profile generator configured to generate an extension process profile by associating an additional basic process profile generated by executing an execution file downloaded or created while generating the basic process profile with a conventional basic process profile.

2. The apparatus for generating the process activity profile of claim 1, wherein the basic process profile generated by the basic process profile generator includes a profile with respect to an execution operation, a file creation operation, a connection creation operation, a file upload operation, a file download operation, and a termination operation.

3. The apparatus for generating the process activity profile of claim 1, further comprising:
a profile storage unit configured to store the basic process profile generated by the basic process profile generator and the extension process profile generated by the extension process profile generator.

4. The apparatus for generating the process activity profile of claim 1, wherein the basic process profile generated by the basic process profile generator and the basic process profile added by the extension process profile generator include sequence information.

5. A method of generating a process activity profile, comprising:
executing basic process profiling for generating a basic process profile recording an operation of a specific process in a system; and
executing extension process profiling generating an extension process profile by associating an additional basic process profile generated by executing an execution file downloaded or created through the basic process profiling with a conventional basic process profile.

6. The method of generating the process activity profile of claim 5, after the executing of the basic process profiling, further comprising:
storing the basic process profile generated in the executing of the basic process profiling in a storage unit.

7. The method of generating the process activity profile of claim 5, after the executing of the extension process profiling, further comprising:
storing the extension process profile generated in the executing of the extension process profiling in a storage unit.

8. The method of generating the process activity profile of claim 5, after the executing of the extension process profiling, further comprising:
determining whether the process is malicious using the extension process profile generated in the executing of the extension process profiling.

9. The method of generating the process activity profile of claim 5, wherein the basic process profile generated in the executing of the basic process profiling includes a profile with respect to an execution operation, a file creation operation, a connection creation operation, a file upload operation, a file download operation, and a termination operation.

10. The method of generating the process activity profile of claim 5, wherein the basic process profile generated in the executing of the basic process profiling and the basic process profile added in the executing of the extension process profiling include sequence information.
